(19) United States
(12) Patent Application Publication
(10) Pub. No.: US 2018/0189471 A1
(43) Pub. Date: Jul. 5, 2018

(54) Visual CAPTCHA Based On Image Segmentation

(71) Applicant: Facebook, Inc., Menlo Park, CA (US)

(72) Inventor: Balmanohar Paluri, Mountain View, CA (US)

(21) Appl. No.: 15/395,618

(22) Filed: Dec. 30, 2016

(51) Int. Cl. G06F 21/36; G06F 21/62

(52) U.S. Cl. CPC G06F 21/36; G06F 21/6218

(57) ABSTRACT

In one embodiment, a method includes receiving a request for a protected resource, providing information to display a challenge-response test, where the challenge-response test includes an image and instructions to provide user input in relation to the image, the image comprises one or more masks, and each of the masks is defined by a perimeter, receiving user input in relation to the image, generating an assessment of the user input based on a correlation between the user input and the masks, determining, based on the assessment, whether the user input corresponds to human-generated input, and if the user input may be deemed responsive to the instructions, then providing information to access the protected resource, else providing information indicating that the user input failed the challenge-response test. Each of the masks may include a classification, and the instructions may provide user input in relation to the classifications.

### TECHNICAL FIELD

This disclosure generally relates to identifying and classifying objects in images for use in challenge-response tests that can distinguish between human and non-human input.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, a challenge-response test can present a challenge question about objects in an image and determine whether a response is from a human user by comparing the response to characteristics of the objects, such as their positions in the image, their types, and other information, such as social-networking information. Distinguishing between human and non-human input is useful, for example, to prevent automated systems from impersonating human users when accessing protected online resources, e.g., reserving many tickets for an event in a short period of time. A system that determines whether input is from a human using a challenge-response test is referred to as a CAPTCHA (Completely Automated Public Turing test to tell Computers and Humans Apart). In particular embodiments, CAPTCHA features are provided using image segmentation and classification. For example, in an image that contains a photo of a person and a table, the perimeters of the person and table may be identified by an image segmentation technique, and the types of the objects may be identified as “person” and “table” by an image classification technique. When a request to access a protected resource is received, a challenge may be displayed. The challenge may include the image and instructions to trace the perimeter(s), e.g., outlines, of one or more specified objects identified by their classification(s) (e.g., the person and table, or each animal separately, or the animals as a group) in the displayed image. A user may respond to the challenge by tracing the perimeters of the specified objects, e.g., using a touch screen, pointing device, or other input device.

In particular embodiments, the perimeters provided by the user may be compared to corresponding expected perimeters for the specified objects generated by image segmentation and classification (which may generate the perimeters based on segment masks). To compare perimeters, a similarity score for the user-provided perimeters and the corresponding expected perimeters may be calculated based on metrics such as the percentage of pixels that intersect in the two perimeters. If the similarity score is sufficiently high, then the response is likely from a human, and instructions or permission for accessing the protected resource may be provided to the user.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates example objects in an image.

FIG. 4 illustrates example perimeters of masks for objects in an image.

FIG. 5 illustrates example masks for objects in an image.

FIG. 6 illustrates example object perimeters received as challenge responses for an image.

FIG. 7 illustrates an example line connecting objects as a challenge response for an image.

FIGS. 8A and 8B illustrate example response perimeters and expected perimeters.

FIG. 9 illustrates an example method for controlling access to a resource using a challenge-response test based on image segmentation and classification.

FIG. 10 illustrates an example interaction diagram between a client system and a server in a challenge-response test.

FIG. 11 illustrates an example computer system.

### DESCRIPTION OF EXAMPLE EMBODIMENTS

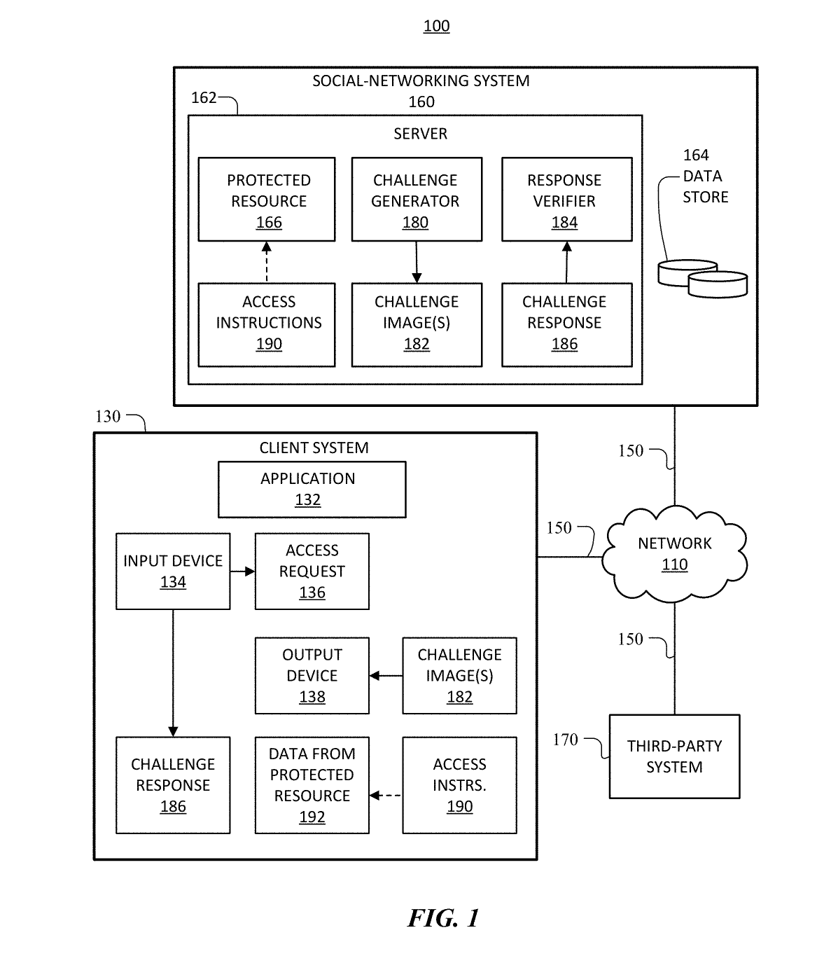

FIG. 1 illustrates an example network environment 100 associated with a social-networking system. Network environment 100 includes a user 101, a client system 130, a social-networking system 160, and a third-party system 170 connected to each other by a network 110. Although FIG. 1 illustrates a particular arrangement of user 101, client system 130, social-networking system 160, third-party system 170, and network 110, this disclosure contemplates any suitable arrangement of user 101, client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of users 101, client systems 130, social-networking systems 160, third-party systems 170, and networks 110, this disclosure contemplates any suitable number of users 101, client systems 130, social-networking systems 160, third-party systems 170, and networks 110. As an example and not by way of limitation, network environment 100 may include multiple users 101, client system 130, social-networking systems 160, third-party systems 170, and networks 110.

In particular embodiments, user 101 may be an individual (human user), an entity (e.g., an enterprise, business, or third-party application), or a group (e.g., of individuals or entities) that interacts or communicates with or over social-networking system 160. In particular embodiments, social-networking system 160 may be a network-addressable computing system hosting an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include an authorization server (or other suitable component(s)) that allows users 101 to opt in to or opt out of having their actions logged by social-networking system 160 or shared with other systems (e.g., third-party systems 170), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 30 through blocking, data hashing, anonymization, or other suitable techniques as appropriate. Client system 130 may be any suitable computing device, such as, for example, a personal computer, a laptop computer, a cellular telephone, a smartphone, a tablet computer, or an augmented/virtual reality device.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

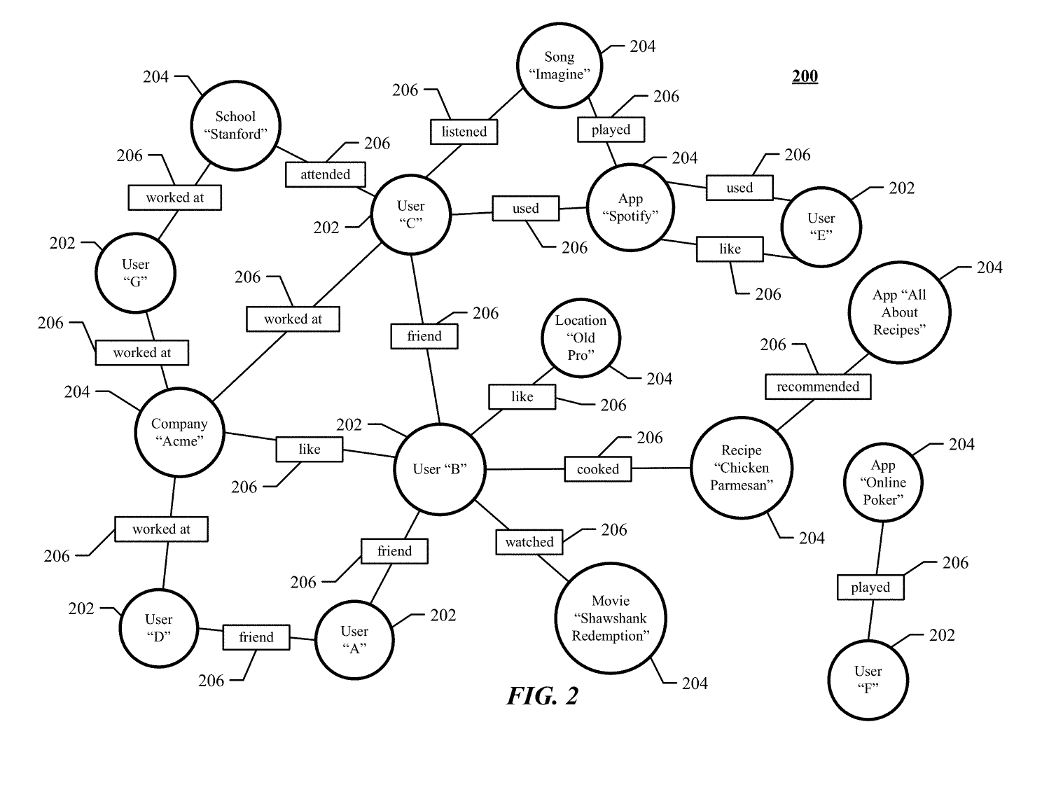

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 130 to send to social-networking system 160 a message indicating the user's action. In response to the message, social-networking system 160 may create an edge (e.g., a check-in-type edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 164. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to an edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 160). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 160 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 160) or RSVP (e.g., through social-networking system 160) to an event associated with the advertisement. In addition or as an alternative, an advertisement may include social-networking-system content directed to the user. As an example and not by way of limitation, an advertisement may display information about a friend of the user within social-networking system 160 who has taken an action associated with the subject matter of the advertisement.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 204 corresponding to a particular photo may have a privacy setting specifying that the photo may only be accessed by users tagged in the photo and their friends. In particular embodiments, privacy settings may allow users to opt in or opt out of having their actions logged by social-networking system 160 or shared with other systems (e.g., third-party system 170). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 162 may be authorization/privacy servers for enforcing privacy settings. In response to a request from a user (or other entity) for a particular object stored in a data store 164, social-networking system 160 may send a request to the data store 164 for the object. The request may identify the user associated with the request and may only be sent to the user (or a client system 130 of the user) if the authorization server determines that the user is authorized to access the object based on the privacy settings associated with the object. If the requesting user is not authorized to access the object, the authorization server may prevent the requested object from being retrieved from the data store 164, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

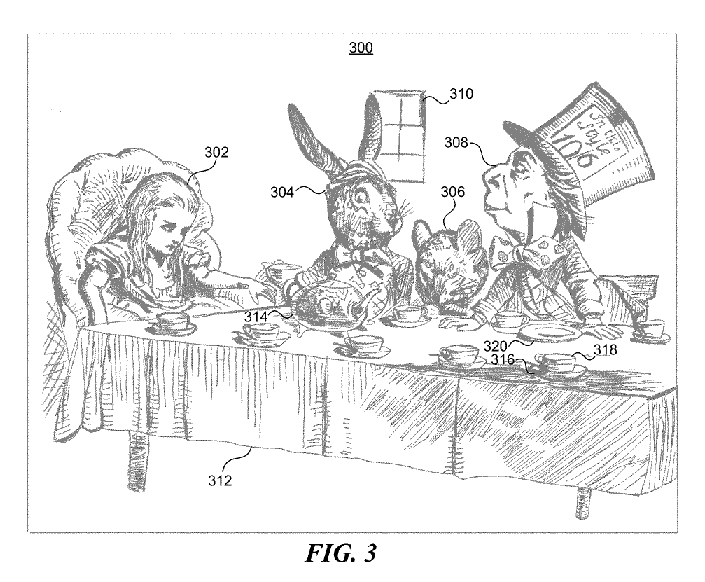

In particular embodiments, a system may display an image on a client system 130, then automatically identify objects in the image and provide feedback, such as written or spoken audio descriptions of the objects, in response to user gestures. The gestures may be associated with an image, e.g., gestures that cause the image to be displayed, in which case descriptions of the objects in the image may be provided to the user. The gestures may also touch, point to, or otherwise indicate specific portions of the image, in which case the system may identify specific objects displayed in the image at the locations indicated by the gestures. Descriptions of the identified objects may then be provided to the user. An object may be any suitable identifiable item in an image (e.g., a person, an animal, an arm, a leg, a cup, etc.). Objects of many types can be identified accurately by a human viewing the image. For example, FIG. 3 illustrates several objects in an image, including a person, two animals sitting at a table, and several tea cups and a tea pot on the table.

An automated system may thus identify and classify the objects in images, and use the resulting information to interact with users in ways that may have previously been difficult or impractical to implement. For example, the information may be used to describe the content of photos to blind users. An audio description such as “photo contains a girl, a hare, a mouse, a man in a hat, and a table” may be played or spoken by a text-to-speech system. The techniques disclosed herein can provide immersive experiences that allow users to perceive the objects in a photo by swiping their finger across an image on a touch screen display and having the system describe the content they are touching.

FIG. 3 illustrates example objects 302-320 in an image 300. In particular embodiments, objects in an image may be identified and classified by algorithms using machine-learning techniques. Objects 302-320 may be identified using image segmentation techniques such as DeepMask and SharpMask, and classified using image classification techniques such as MuiltiPathNet. Image Segmentation methods are disclosed in U.S. Patent Application 62/351,851, filed 17 Jun. 2016, which is incorporated herein by reference. Although specific techniques are described for image identification and classification, other techniques may be used to identify image segments that correspond to objects and classify the objects. Information identifying an object may include the location of the object in the image and the perimeter of the object, e.g., coordinates of the object and of the pixels that form the perimeter of the object. An object may have an associated object type, which may correspond to a classification determined by an image classification technique. The object type may be a classification such as person or human for an Alice object 302 and a Mad Hatter object 308, hare for a March Hare object 304, mouse for a Dormouse object 306, window for a window object 310, hat for a Mad Hatter's hat, table for a table 312, tea pot for a tea pot 314, tea cup a the tea cup 318, and saucer for saucers 316, 320. The information identifying an object may also include an object name that identifies a specific instance of the object type, e.g., “Alice” may be identified as the name of the Alice object 302, and “March Hare” may be identified as the name of the March Hare 304.

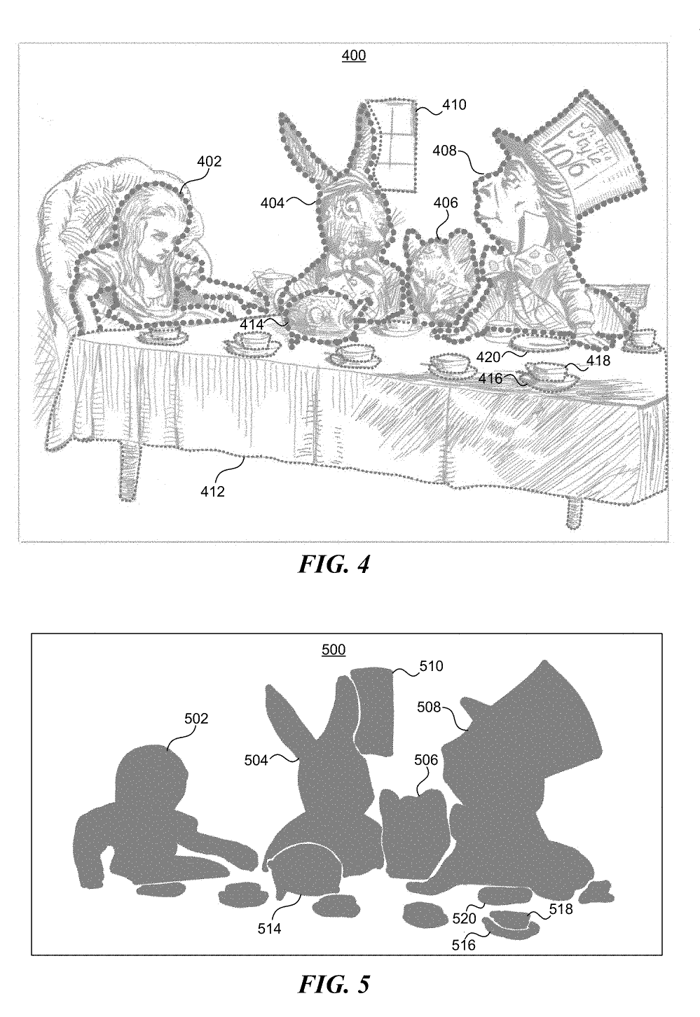

FIG. 4 illustrates example perimeters 402-420 of objects in an image, and FIG. 5 illustrates masks 502-520 for the objects in the image. The identification and classification of objects may involve image recognition. For example, a mask 502 may be identified that corresponds to an Alice object 302 in the image 300, and may be classified as a person via image recognition. Masks 502-520 correspond to the respective objects 302-320 and are bounded by the respective perimeters 402-420. For example, the perimeters shown in FIG. 4 include an Alice perimeter 402 for the Alice object 302, a Mad Hatter perimeter 408 for the Mad Hatter object 308, a March Hare perimeter 404 for the March Hare object 304, a Dormouse perimeter 406 for the Dormouse object 306, a window perimeter 410 for the window object 310, a table perimeter 412 for the table object 312, tea pot perimeter 414 for the tea pot object 314, a tea cup perimeter 418 for the tea cup object 318, and saucer perimeters 416, 420 for the saucer objects 316, 320.

In particular embodiments, mask 502 may be defined by a perimeter 402 of an object 302, and ordinarily includes a data structure representing the positions of the pixels in the mask 502, which may be based on the positions of corresponding pixels in the object 302. As can be seen in the example of FIG. 5, the shapes of the masks 502-520 correspond to the shapes of the object perimeters 402-420, which in turn correspond to the shapes of the objects 302-320. For example, the masks shown in FIG. 5 include an Alice mask 502 for the Alice object 302, a Mad Hatter mask 508 for the Mad Hatter object 308, a March Hare mask 504 for the March Hare object 304, a Dormouse mask 506 for the Dormouse object 306, a window mask 510 for the window object 310, a tea pot mask 514 for the tea pot object 314, a tea cup mask 518 for the tea cup object 318, and saucer masks 516, 520 for the saucer objects 316, 320.

Objects may overlap other objects, e.g., the tea pot 314 overlaps the hare 304 and the table 312, and the hare 304 overlaps the window 310. The image segmentation algorithm may identify an object that overlaps another object and generate the perimeters 402-420 (and masks 502-420) accordingly. In one example, any pixel within the tea pot perimeter 414 corresponds to the tea pot 314, any pixel within the March Hare perimeter 404 correspond to the March Hare 304, and the pixels within the tea pot perimeter 414 do not correspond to the March Hare 304 (even though the tea pot 314 occupies a region that would otherwise contain part of the March Hare 304 if the tea pot 314 were not present), because the tea pot 314 overlaps the March Hare 304. Similarly, the pixels within the window perimeter 410 correspond to the window 310, except for the pixels in the portion of the window 310 overlapped by the March Hare 304, which correspond to the March Hare 304. The boundaries between the overlapping objects 314, 304, and 310 are shown as white space between the masks 514, 504, and 510 in FIG. 5 for illustrative purposes. In one embodiment, the boundaries between overlapping objects are not empty regions, but instead correspond to the locations at which pixels from one object meet pixels from another object. Thus, a user 101 may slide a finger from the March Hare 304 to the tea pot 314, and when the finger first touches a pixel in the tea pot 314, which corresponds to a pixel in the mask 514, the tea pot 314 becomes the object designated by the finger. The gap between adjacent masks in FIG. 5 is shown for illustrative purposes. Pixels of the March Hare mask 504 may be adjacent to pixels of the tea pot mask 514 in the region shown as a gap between the two masks.

In particular embodiments, there may be a boundary between overlapping objects 304, 314, which may be displayed as part of the image 300 and/or represented as data associated with the adjacent masks 504, 514. The boundary may be displayed to assist the user 101 in distinguishing between overlapping objects, for example. In one example, the boundary may be shown by displaying the perimeters around the objects, such as the March Hare perimeter 404 and the tea pot perimeter 414. The perimeters may be displayed as shown in FIG. 4, e.g., as dashed or dotted lines of any appropriate width or color, or as solid lines of any appropriate width or color. In another example, only the portions of the perimeters that are between the overlapping objects, e.g., the portions of a perimeter that overlap a perimeter of another mask, may be shown, to indicate the boundaries between overlapping objects. In this example, the portion of the tea pot perimeter 414, which may overlap the March Hare perimeter 404, may be displayed as a boundary between the tea pot 314 and the March Hare 304. Some masks may be non-classified, e.g., object recognition may fail to recognize an object, or may have a low certainty about an identified object.

Image segmentation or classification may identify object types, and may also identify relationships or properties of objects. As an example, classification may determine that one object is behind another object, or that an object is red. Relationships between objects may be identified based on other objects in an image. For example, in an image depicting a bus and a person, the relative positions of the bus and person may be determined based on a known size ratio between people and buses. In this example, the bus being relatively small in the image and the person relatively large in the image compared to the known ratio may indicate that the bus is farther away than the person, so the bus is behind the person. If, e.g., an object 304 is identified as being behind or in front of another object 314, then this relationship may be included as part of the description of either or both of the objects. For example, when a user 101 selects an object 304 that is behind another object 314, the description may include a displayed or spoken indication that the object is behind the other object. If a user 101 selects the March Hare 305, e.g., by swiping on or pointing to it, then the description “A rabbit behind a tea pot”, “The Match Hare behind a tea pot,” or “The March Hare, which is a rabbit, behind a tea pot, which is on a table” may be displayed or spoken to the user.

When two or more of the objects 304, 314 in an image 300 overlap, the corresponding masks 504, 514 may be non-overlapping, with boundaries between the masks 504, 514 at the boundaries between overlapping objects 304, 314. Alternatively, the masks 504, 514 may overlap, in which case the mask 514 corresponding to the object 314 closest to the front (e.g., the front-most mask) may be selected when the user 101 selects a pixel that is on each of the overlapping masks (e.g., a pixel in the region of the image in which the objects 304, 314 intersect). In particular embodiments, both an overlapping object, such as the tea pot 314, and an overlapped object, such as the March Hare 304, may be identified as occupying the same region, which is ordinarily an intersection of the regions occupied by the two objects 304, 314 in the image 300. For example, the image segmentation algorithm may determine that the March Hare 304 occupies a portion of the region behind the tea pot 314, which is the region above the upper line of the table occupied by the upper half of the tea pot 314. The image segmentation algorithm or other component of the system may then determine that there is a portion of the March Hare 304 behind a portion of the tea pot 314 (e.g., behind approximately the top half of the tea pot 314). As a user 101 swipes over the tea pot 314, the audio may play “tea pot in front of a hare.” As the user 101 swipes over the March Hare 304, the audio may play “March Hare behind a tea pot and in front of a window.” The positions of the overlapping masks 504, 510 relative to each other may also be included in the description. For example, since the window 310 is near the upper portion of the March Hare 304, the audio may play “upper portion of hare in front of a window.” If the image segmentation algorithm identifies the hare's ears as objects, then the audio may play “window behind hare's right ear” when the user 101 swipes over the window 310. If the image segmentation identifies the hare's head as well, then the audio may play “window behind hare's right ear and head” or “hare's right ear and head in front of window” when the user 101 swipes over the window 310 or hare 404, respectively.

In the tea cups on a table example, the masks for the tea cups and the table may overlap. The image segmentation algorithm may determine that a portion of the saucer 316 is behind the tea cup 318, and the table 312 is behind both the saucer 316 and the tea cup 318. Thus a particular region of the image 300 may correspond to multiple overlapping masks 516, 518 or to a subset of the multiple overlapping masks. As a user 101 swipes over the tea cups 318, the audio may indicate “tea cup on a table.” Alternatively, the audio may identify the smaller mask, by indicating, for example, only “tea cup.” A user 101 may also cycle through overlapping masks 516, 518 with a gesture. Using the example above, if the user 101 taps on the mask 518 that corresponds to the tea cup 318, audio may play “tea cup” and if the user 101 taps a second time, audio may play “table.”

In particular embodiments, social-networking data may be used to help identify objects. For example, if a user 101 has a particular cat (e.g. “Fluffy”), depicted in multiple images, the cat may be identified as the particular cat. As another example, the context of the picture may aid in identifying objects. For example, geo-location data indicating that an image was taken at Fort Point in San Francisco may make it more likely that an object is the Golden Gate Bridge. As another example, photo albums may contain similar images, so that if an object is identified in an image in an album, a given object in another image of the album is more likely to be the same object.

A mask 502 may be represented as a matrix of values that correspond to pixels of the image 300 and indicate whether the corresponding pixel is in the corresponding object 302 (e.g., value=1 or true) or not in the object 302 (e.g., value=0 or false). The position of each value in the matrix corresponds to the position of a pixel in the object 302. The mask 502 thus specifies the shape of the object 302, and includes a specification (which may be implicit or explicit) of the perimeter 402 of each object. The perimeter 402 may be specified by the locations of adjacent 0 and 1 values in the mask matrix. The mask 502 ordinarily corresponds to a portion of the image 300 having dimensions in pixels that are sufficiently large to include the object 302. The location in the image 300 to which the mask corresponds, e.g., the coordinates of the top left corner of the mask 502 in the image 300, may be included in or associated with the mask 502. Although the mask 502 is described herein as having a particular value (e.g., 1 or true) for each entry that corresponds to a pixel in the object 302, other representations may be used, such as a mask 502 in which only the entries that form a 1-pixel-wide perimeter 402 around the object 302 are set to a value (e.g., 1 or true) indicating that they correspond to the object 302. Although the perimeter 402 is described as being represented by the mask 502, other representations are possible, e.g., a set of curves or vectors that can be mapped to pixels to identify a perimeter 402 at the pixel level in an image 300. Further, although the mask 502 is described as being represented by a matrix, other representations are possible, e.g., a list of (x,y) coordinates that are included in the object, a list of points that can be interpolated, one or more curves or vectors that can be mapped to pixels, and so on.

In particular embodiments, the perimeter 402 that corresponds to a mask 502 may be the same as a perimeter that a human viewing the image 300 would identify for the object 302, as may occur when there is strong contrast between the object 302 and its surroundings in the image 300, e.g., a dark object 302 against a light background of a different color. However, the perimeter 402 of an object 302 may be ambiguous or difficult to identify precisely, e.g., when the boundaries between the object 302 and its surrounds are amorphous. Thus, the perimeter 402 that corresponds to the mask 502 may differ from the perimeter a human would identify, but ordinarily such differences are small (e.g., variations of several pixels in distance), and a human would agree that the perimeter 402 specified by the mask 502 is a reasonable for the object 302. Further, a mask need not be contiguous (e.g., an object may have multiple noncontiguous parts, or may be partially occluded by another object).

In particular embodiments, a mask 502 may have a touch area that differs from the area of the mask 502. For example, a mask such as the teacup mask 518 may be relatively small, and the touch area of the mask 518 may be increased to a size greater than the size of the mask 518. Increasing the touch area in this way may, for example, help a user 101 by providing larger touch areas for small masks. However, the increased touch area of the mask 518 should not overlap other masks, such as the mask 516 for the saucer 316 that is adjacent to the mask 518.

In particular embodiments, an object in an image may contain other smaller objects. That is, at least a portion of the object and at least a portion of each of the smaller objects may be visible, with the smaller objects overlapping the larger objects. The smaller objects may in turn contain still smaller objects, and so on. An object that is contained in another object is referred to herein as a nested object and may be identified and classified as described above. Thus an object that contains nested objects may have a mask that corresponds to the shape of the object in the image 300. Nested objects located within the object may also be associated with masks that correspond to the shapes of the nested object. The image segmentation algorithm may generate a list of objects nested within an object, and associate the list with the object, so that interactions with the user 101 can provide the list of objects to the user. For example, when a user 101 points to or swipes on an object that contains nested objects, the system may provide a description, e.g., by displaying text, generating braille script, or playing audio, stating that the object contains other objects, along with the types (or names) of the other objects. As another example, if the user 101 points to or touches one of the nested objects, the system may provide a description including the type or name of the nested object, and optionally, of the object within which it is nested. In another example, the system may provide descriptions of all the objects nested within an object, and the descriptions of the objects may be separated by prompts for a command to continue or stop describing the objects in the list. A size threshold may be associated with each nested object, so that if an object contains one or more objects that are smaller than the size threshold (e.g., have an area smaller than the size threshold), then the system may provide descriptions of the nested objects as well as the containing object as described above when the user 101 swipes, points to, or touches the containing object. As a further example, for each nested object that is larger than the size threshold, the system may provide a description for a nested object only when the nested object itself is selected (e.g., by swiping, pointing, touching, or making another gesture that designates the nested object's mask).

In particular embodiments, as introduced above, the system may provide feedback in response to user gestures. The gestures may be received by an input device via an I/O interface 908 of a client system 130, e.g., a touch screen, trackpad, mouse or other pointing device, virtual reality glove, eye tracking device, or other sensor that detects human actions. The gestures may touch, point to, or otherwise indicate specific portions of the image 300, in which case the system may identify specific objects 302 displayed in the image at the locations indicated by the gestures. For example, the gesture may be a finger touching a screen of the client system 130 at a location where an object in the image 300 is displayed. In this case, feedback may be provided on the device's screen, through the client device's audio output (e.g., speaker), or by any other type of output that can be generated by the device client device 130 (e.g., haptic feedback). This system may have particular applications in, for example, aiding the blind, teaching children, learning a foreign language, and other tasks that involve communication with humans.

Feedback may be produced in response to the gesture input. Audio identifying the classification of a mask may play as a user 101 touches a portion of an image 300 corresponding to one or more of the masks 502-520. For example, if an image 300 features a lighthouse on a coast, a mask may be generated over the lighthouse, the mask may be classified as a lighthouse, and a user 101 may touch the image in a location corresponding to the lighthouse. As the user 101 touches the lighthouse, the client device 130 may play audio indicating that the user 101 is touching the lighthouse. As another example, the gesture may be a swiping gesture. As the swiping gesture moves between portions of an image corresponding to different masks, audio may be played corresponding to the different masks. For example, if an image 300 includes a tea cup 318 on a saucer 316, a user 101 may swipe across the image 300, and audio identifying the saucer 316 and tea cup 318 may be played when the gesture reaches the corresponding masks 516, 518.

The feedback provided in response to a user gesture may be any type of suitable feedback. The feedback may be provided when for example, a user's gesture leaves or enters an area corresponding to a mask. Example types of feedback include audio, haptic, or visual. Audio feedback may include audio describing the object corresponding to an object. Haptic feedback may include vibrating the client system 130 when, e.g., a user's gesture leaves or enters an area corresponding to a mask. Visual feedback may include displaying a textual description of the object, e.g., “a tea cup” or “a tea cup on a table.” There may also be feedback as a user's gesture transitions from a mask to a portion of an image without a mask or with an unidentified mask. For example, a sound may play or the device may vibrate when these transitions occur. In cases where feedback is haptic, vibrating speed or intensity may vary, e.g., as an indication that a user's gesture is approaching the edge of a mask.

Masks from related images may be overlaid on an image. For example, one image may depict a box having an open lid and contents, and masks may be generated for the contents of the box. A second image may depict the box with its lid closed. The masks for the contents of the box may be overlaid on the second image with the lid closed.

In particular embodiments, a challenge-response can present a challenge question about objects in an image and determine whether a response is from a human user by comparing the response to characteristics of the objects, such as their positions in the image, their types, and other information such as social-networking information. Distinguishing between human and non-human input is useful, for example, to prevent automated systems from impersonating human users when accessing protected online resources, e.g., reserving many tickets for an event in a short period of time. A system that determines whether input is from a human using a challenge-response test is referred to as a CAPTCHA (Completely Automated Public Turing test to tell Computers and Humans Apart). In particular embodiments, CAPTCHA features are provided using image segmentation and classification. For example, in an image that contains a photo of a person and a table, the perimeters of the person and table may be identified by an image segmentation technique, and the types of the objects may be identified as “person” and “table” by an image classification technique. When a request to access a protected resource is received, a challenge may be displayed. The challenge may include the image and instructions to trace the perimeter(s), e.g., outlines, of one or more specified objects identified by their classification(s) (e.g., the person and table, or each animal separately, or the animals as a group) in the displayed image.

In particular embodiments, a user may respond to the challenge by tracing the perimeters of the specified objects using a touch screen, pointing device, or other input device. The perimeters provided by the user may be compared to corresponding expected perimeters for the specified objects generated by image segmentation and classification (which may generate the perimeters based on segment masks). To compare perimeters, a similarity score for the user-provided perimeters and the corresponding expected perimeters may be calculated based on shape similarity metrics such as the percentage of pixels that intersect in the two perimeters, an average geometric distances between the perimeters, a Hamming or Hausdorff distance between the two perimeters, or the like. If the similarity score indicates that the two perimeters are sufficiently similar, then the response is likely from a human, and instructions or permission for accessing the protected resource may be provided to the user.

In particular embodiments, the challenge instructions may request that the specified objects be identified in ways other than tracing perimeters. For example, the instructions may request that a line be drawn through the specified objects, that a point be selected within the perimeter of each of the specified objects. The score may be based on other types of correlations between attributes of the specified objects and attributes indicated by user input, such as locations, names, labels, colors, and so on. If the request is associated with a particular user, then content associated with the user, such as social-network information for the user, may be included in the image, and the instructions may request input related to the content associated with the user. Other types of input may be requested, such as input designating images that contain a specific type of object. The tasks of identifying and classifying the objects in the image should be sufficiently difficult, e.g., computationally intensive, that attacks on the challenge-response test that perform the tasks automatically using a computer system are not practical.

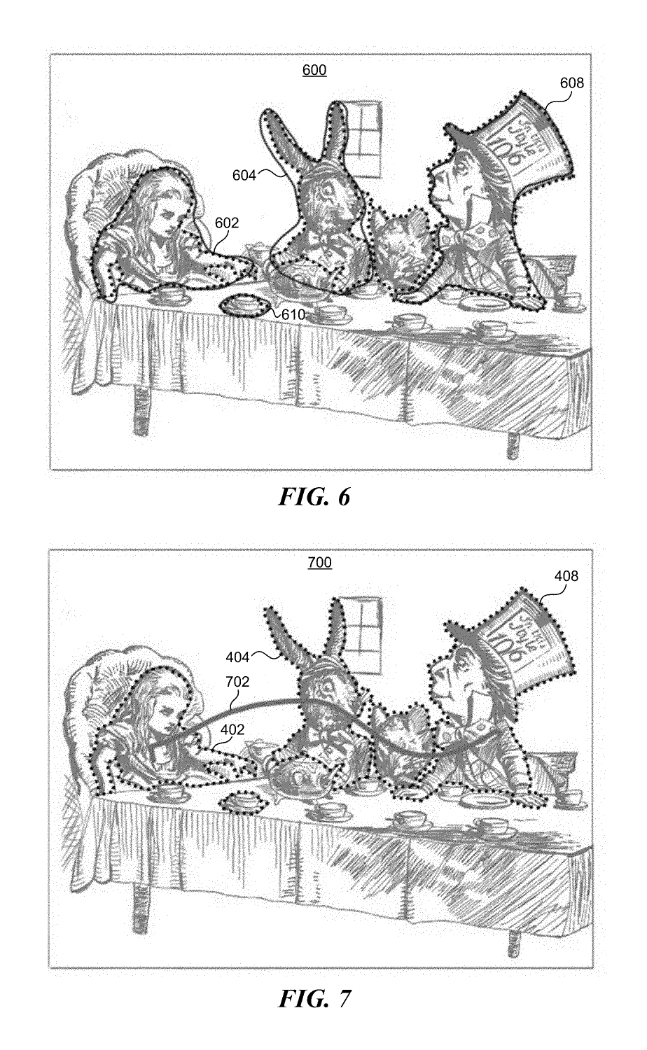

FIG. 6 illustrates example object perimeters received as challenge responses for an image 600. The image 600 corresponds to the images 300, 400, and 500 shown in FIGS. 3, 4, and 5, respectively, and includes an Alice object 302 having an Alice response perimeter 602, a March Hare object 304 having a March Hare response perimeter 604, a Mad Hatter object 308 having a Mad Hatter response perimeter 608, and a cup with saucer object having a cup with saucer perimeter 610. The response perimeters 602-610 may be received from an input device, e.g., a touch screen sensor, a pointing device such as a mouse, or other appropriate device with which the user may trace (e.g., draw) the perimeters 602-610. As an example, the image 600 may be displayed on a screen as the challenge portion of a challenge response test. Instructions may be displayed requesting that the user trace, draw, or otherwise identify the perimeter of one or more specified objects in the image. In particular embodiments, the image 600 may include content associated with the user, and the challenge instructions may be customized for the user. For example, the image 600 may include an image of one of the user's first-degree friends or an entity that the user has marked as “liked.” The challenge instructions may then request the user to select or trace a perimeter around a first-degree friend or around an entity that the user has marked as “liked.”

In one example, the instructions may request that the perimeter of one or more specified objects in the image 600 be traced, e.g., the perimeters of Alice, the March Hare, the Mad Hatter, and/or the cup with saucer. The instructions may state, “Please trace an outline around the human” or “Please trace around the edge of Alice in the picture,” and the user may accordingly trace the response perimeter 602 using an appropriate input device. The input received may be compared to an expected perimeter 402 or the Alice object 302. As another example, the instructions may state “Please trace outlines around the edges of Alice, the March Hare, and the Mad Hatter,” and the input received may be compared to expected perimeters 402, 404, 408 of those three objects (e.g., by comparing the intersection of the corresponding masks, as described below, or by other comparison technique). Although particular response perimeters are illustrated, they are examples, and other perimeters may be traced by the user for the illustrated objects (or for different objects).

One or more of the respective response perimeters 602-610 may be received as input. The response perimeters 602-610 received as input in response to the challenge are shown as solid perimeters, each of which corresponds to an object in the image. Expected perimeters for the challenge-response test are shown as dotted lines and are similar to or the same as the perimeters 402, 404, 408 shown in FIG. 4. The expected perimeters 402, 404, 408 may be generated by an image segmentation technique, e.g., by generating masks 502, 504, 508 and using the perimeters of the masks as the expected perimeters 402 404, 408 of the corresponding objects 302, 304, 308. The illustrated response perimeters 602-610 may be traced by a user, e.g., by drawing the response perimeters 602-610 around the corresponding objects 302-310.

The user may be instructed to draw the response perimeters as close to the perimeters of the objects 302-310 as possible, but the response perimeters are not ordinarily expected to be the same as the expected perimeters 402, 404, 408. For example, a response perimeter 602 provided by a user is ordinarily not a precise perimeter 402 of an object 302, but instead may deviate from the perimeter of the object 302, e.g., because the user draws the perimeter quickly, or the input device, such as a touch screen, does not have sufficient precision for the user to precisely trace the perimeter 402 of the object 302. Further, the exact location of portions of the perimeter 402 may be ambiguous, e.g., because another object hides the perimeter, such as the lower portion of the 304 March Hare 304, which is hidden by the tea pot 314.

In particular embodiments, the similarity between the input perimeter 602 for an object and an expected perimeter 402 (determined by image segmentation) may be understood as a measure of how closely the response perimeter 602 matches the expected perimeter 402. The perimeter similarity may be determined by, for example, dividing the number of pixels (or other block units, e.g., 4×4 pixel blocks) that are in the intersection of the mask defined by the response perimeter 602 with the mask defined by the expected perimeter 402 by the total number of pixels (or other block units) in both masks (e.g., in the union of the two masks). As described above with reference to FIG. 5, a mask 502 may be defined by a perimeter 402 of an object 302, and may be understood as the area defined by, e.g., enclosed within, the perimeter. The similarity score produced by the mask intersection calculation may be a value between 0 and 1, with 0 indicating no intersection and therefore no similarity, and 1 indicating that the objects have identical shapes (and identical positions, if absolute pixel coordinates are used in the calculation).

In particular embodiments, the location of the response perimeter 602 in the image 600 relative to the location of the expected perimeter 402 may be used in the calculation of the similarity score. The locations may be included in the calculation by, for example, using absolute pixel coordinates that are relative to a fixed location in the image, e.g., the top left of the image. If there are two or more different objects having identical or nearly identical shapes in the image 600, the challenge instructions may indicate that any of the objects may be selected.

In particular embodiments, the challenge instructions may indicate that a particular one of the objects is to be selected, in which case the challenge instructions describe the position of the expected perimeter 402. When a particular one of the similar or identical shapes is specified in the instructions, the correct response may be based on the location of the expected perimeter 402 in the image 600 as well as the shape of the expected perimeter 402. For example, there are multiple tea cups in the image 600. If two or more of the tea cups have the same shape, and the instructions indicate that the tea cup at the top left of the table is to be selected (or, as another example, the tea cup nearest the March Hare) is to be selected, and relative coordinates are used in the similarity calculation, then the coordinates of the expected perimeter of the tea cup at the top left of the table in the image 600 may be compared to the coordinates of the received response perimeter to verify that the two perimeters are at the same location or within a threshold distance of the same location in the image 600. The coordinates of each perimeter may be relative to a particular point in each image that is in the same position relative to the object in each image or within a threshold distance of the same position in each image, such as the top left pixel of the object in each image.

Other metrics may be used to determine the degree of similarity between the response perimeter 602 and the expected perimeter 402, e.g., by comparing the areas defined by the two perimeters and calculating a quantitative difference in the sizes, shapes, and/or locations of the two perimeters. As another example, the perimeter similarity may be calculated as an average distance between the response perimeter 602 and the expected perimeter 402 from multiple points along one of the perimeters to the closest corresponding point on the other perimeter. The perimeter similarity may be calculated using a Hamming or Hausdorff distance between the two perimeters, or an average of two or more metrics. The Hamming distance is a measure of the area in one of the two perimeters but not both, which can be calculated by finding the intersection and union of the perimeters and then computing the areas. As described above for the mask intersection calculation, the areas may be computed as the sum of pixels or other shape units in the regions of the two perimeters that intersect and in the region covered by the union of both perimeters. The Hamming distance may then be computed as the area of the differences between the spaces enclosed by the perimeters, which is the sum of areas that are in one polygon but not the other. A low Hamming distance indicates that the perimeters are similar, with a distance of 0 indicating that the perimeters are identical and overlapping. As the differences between the perimeters increase, the Hamming distance becomes greater. The Hausdorff distance may be calculated as the greatest of the distances from a point on one perimeter to the closest point on the other perimeter.

Although three perimeters 602, 604, 608 are described in this example, the instructions may specify that any number of perimeters, e.g., 1, 2, 5, or other number, are to be drawn around the same number of identified objects. If an object in an image is overlaid by another object, then the instructions may indicate that the perimeter should not cross the other object, but should instead be traced along the edge of the other object. Alternatively, the instructions may indicate that the portion of the perimeter that passes behind the other object may be a straight line, e.g., a line between the points where the visible perimeter intersects the other object. In one example, the portion of the perimeter hidden by the other object may be excluded from similarity score calculations because of the ambiguity introduced by the other object hiding the perimeter.

In particular embodiments, the challenge instructions may instruct the user to select multiple objects in an image, either individually or as a group. If objects are to be selected as a group, then the instructions may request that the user trace a perimeter around the group of objects, e.g., a single perimeter enclosing all the humans in an image, or enclosing two or more specified objects, such as a single perimeter enclosing the March Hare 304 and the dormouse 306. The instructions may further request that the perimeter be traced as closely to the outer edges of the group as possible. In this case, the response perimeter traced by the user may be compared to a perimeter that bounds the objects in the group to determine the similarity score. In another implementation, an image containing multiple images may be presented, and the instructions may request that the user click or tap on specified objects within each image. For example, the user may be provided with 8 images, 5 of which depict cats. Instead of selecting the 5 images, the user may be asked to click or tap on each cat. In this case, if each click is within a mask (or within a threshold distance from a mask), the response may meet the similarity threshold. A user may be treated as human if they achieve a threshold percentage of successes (e.g., if 80% of the clicks or taps are within the expected perimeter or within a threshold distance from the expected perimeter). Any appropriate gesture that can verify that the user has identified each of the plurality of objects may be received as input. For example, instead of clicking on or tapping each object, the input may be a line traced from one object to the next and then to the next, and so on, as described below with reference to FIG. 7.

The objects that a user is asked to identify may be selected such that a typical user may be expected to recognize them. For example, certain objects may be esoteric for users with particular backgrounds (e.g., many users may be unable to identify an echidna, but most users may be able to identify a tree). Objects that are commonplace (e.g., clouds) may be selected for the challenge question to avoid such issues. Further, images with appropriate objects may be selected based on a user's profile. For example, it may not be appropriate to ask a user in North America to identify a sarod (a stringed instrument used in classical Indian music) or spettekaka (a Swedish dessert). A user profile may indicate a user's demographic information and allow images with inappropriate objects to be filtered.

In particular embodiments, the challenge-response test may be used by the social-networking system, or it may be offered as a service to third parties. The social-networking system may select the images or the third party may be able to select images.

Although particular objects and particular response perimeters are described herein, any objects may be depicted, the instructions may request that any combination of objects be selected by any suitable type of input, such as tracing, selecting or tapping a point, drawing a line through each object to be selected, entering an identifier for the object (e.g., if the image includes a legend designating objects as having particular numbers, then the user may enter one of the numbers to identify an object), describing the objects in text or voice input, or the like.

FIG. 7 illustrates an example line or curve 702 connecting objects 402, 404, 408 as a response to a challenge for an image 700. The image 700 corresponds to the images 300, 400, and 500 shown in FIGS. 3, 4, and 5, respectively. The line or curve 702 may be received from an input device, e.g., a touch screen sensor, a pointing device such as a mouse, or other appropriate device with which the user may trace (e.g., draw) the line or curve 702 to connect one or more objects specified in the challenge instructions. As an example, the image 600 may be displayed on a screen as the challenge portion of a challenge response test, with instructions requesting that the user draw a line or curve connecting two or more specified objects in the image. Optionally, the instructions may request that the line 702 not cross any other objects, such as the dormouse 306 in the example of FIG. 7, though avoiding the non-specified objects may be difficult for some images, such as images in which the specified objects are surrounded or overlapped by other (non-specified) objects.

In particular embodiments, a score may be determined for the line or curve 702 by, e.g., dividing the number of specified objects that the line or curve intersects by the total number of specified objects listed in the instructions. If the instructions specify that the line or curve is to intersect three objects, and it intersects the three specified objects, then the similarity score may be 1. If the line or curve intersects two of the three objects, then the similarity score may be 2/3. Further, if the line or curve does not intersect any of the three objects, then the score may be 0. Thus larger values of the similarity score based on a line or curve correspond to greater similarity between the response and the expected line or curve, up to a maximum similarity of 1. In particular embodiments,

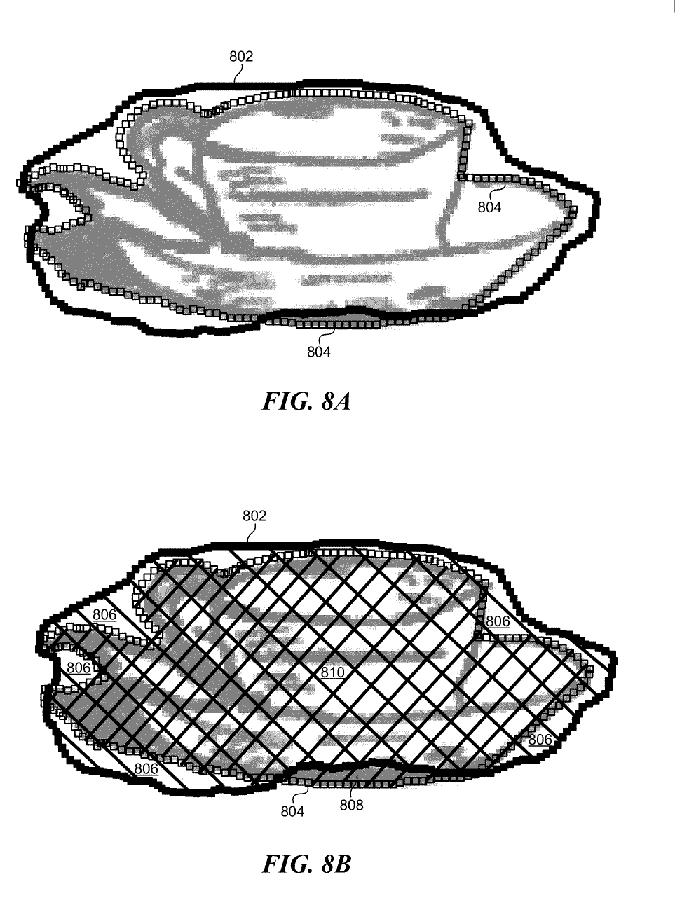

FIGS. 8A and 8B illustrate example response perimeters and expected perimeters. FIG. 8A shows a response perimeter 802 received as input and an expected perimeter 804 calculated using image segmentation for a tea cup object. For illustrative purposes, the response perimeter is shown as solid blocks (e.g., pixels or multiples of pixels), and the expected perimeter is shown as blocks that are not filled. FIG. 8B shows the union and intersection of the response perimeter 802 and the expected perimeter 804. A “response region” enclosed by the response perimeter 802 is shaded with diagonal lines oriented from upper left to lower right, and includes “response only” regions 806 of only the response perimeter 802 that does not overlap the area of the expected perimeter 804. The response region also includes an intersection region 810, which is the intersection of the response perimeter 802 and the expected perimeter 804. An “expected region” enclosed by the expected perimeter 804 is shaded with diagonal lines oriented from lower left to upper right, and includes an “expected only region” 808 of only the expected perimeter 804 that does not overlap perimeter 802. The expected region also includes the intersection region 810.

As an example, a similarity score may be calculated using the mask intersection technique. The similarity score in this example is the area of the intersection region 810 divided by the area of the union of both regions. The union is the sum of the areas of the intersection region 810, the response only region 806, and the expected only region 808. The areas of the regions may be measured in blocks, each of which may correspond to a pixel, or to a group of several pixels, such as a 2×2 pixel block. In one aspect, all blocks in the calculation have the same size, e.g., 1 pixel, 4 pixels, or other size. The blocks or the pixels have associated coordinates that may be compared to the coordinates of the perimeters to identify the blocks that are in the union or intersection, e.g., the blocks that are in the region 806, the blocks in region 808, and the blocks in the intersection region 810. As an example, if the area of the intersection region 810 is 6000 blocks, the total area of the response only regions 806 is 500 blocks, and the area of the expected only region is 1000 blocks, then the intersection area is 6000 blocks, and the union area is 6000+500+000 blocks=7500 blocks. The similarity score is then the intersection area divided by the union area. The result is 6000/7500=0.8. Since a score of 1 corresponds to identical masks, the score of 0.8 corresponds to an 80% similarity. If a similarity score threshold is 0.75 for example, them the score of 0.8 meets the threshold, and instructions, credentials, or permission to access the protected resource may be sent to the user. As another example, if the size of one of the non-intersecting regions 806, 808 is increased without changing the size of the intersection region 810, e.g., because the response perimeter 802 is farther away from the expected perimeter 804 (as may occur when the response perimeter 802 is less accurate), then the similarity score decreases. If the similarity score is below the threshold, e.g., 0.75, 0.66, 0.50, or other threshold, then the response perimeter 802 fails the challenge-response test, and access to the protected resource is not provided. In particular embodiments, the threshold similarity score may depend on the object. For example, objects that are more complicated may have a lower threshold score. Since a human user may have difficulty outlining an object that is too small, in particular embodiments, only objects with masks of a threshold number of pixels (e.g., at least 1000 pixels), or that comprise a threshold percentage of the total pixels in the image (e.g., at least 10% of the image), may be selected for use in the challenge-response test.

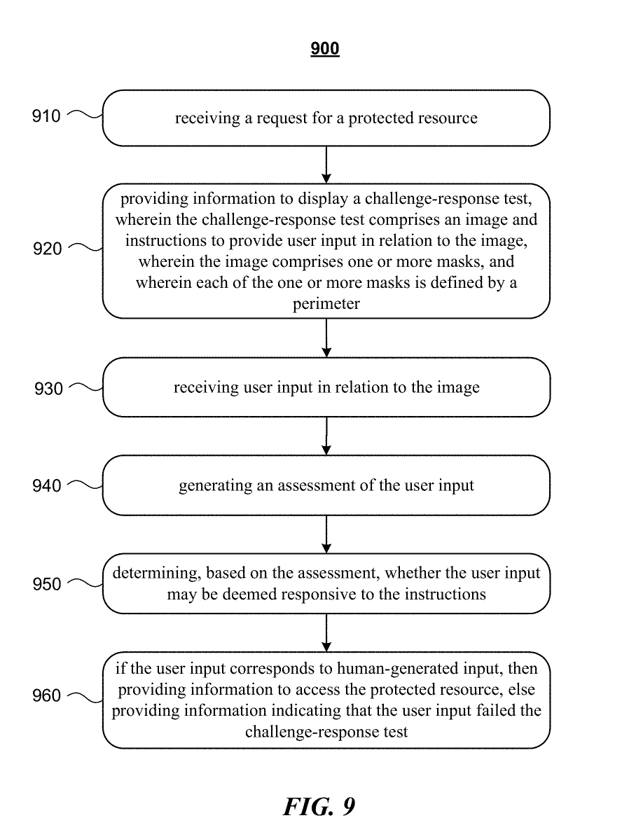

FIG. 9 illustrates an example method 800 for controlling access to a resource using a challenge-response test based on image segmentation and classification. The method may be performed by a server computer system such as the server 162. The method may begin at step 910 by receiving a request for a protected resource. Step 920 may provide information to display a challenge-response test, wherein the challenge-response test comprises an image and instructions to provide user input in relation to the image, wherein the image comprises one or more masks, and wherein each of the one or more masks is defined by a perimeter. Step 930 may receive user input in relation to the image. Step 940 may generate an assessment of the user input based on a correlation between the user input and the one or more masks. Step 950 may determine, based on the assessment, whether the user input may or can be deemed responsive to the instructions. For example, step 950 may determine whether the user input corresponds to human-generated input, in which case the user input may be deemed responsive to the instructions. If the user input does of correspond to the human-generated input, then the user input may be deemed non-responsive to the instructions. Step 960 may provide information to access the protected resource if the user input corresponds to human-generated input, or else provide information indicating that the user input failed the challenge-response test.

Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for controlling access to a resource using a challenge-response test based on image segmentation and classification including the particular steps of the method of FIG. 9, this disclosure contemplates any suitable method for controlling access to a resource using a challenge-response test based on image segmentation and classification including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

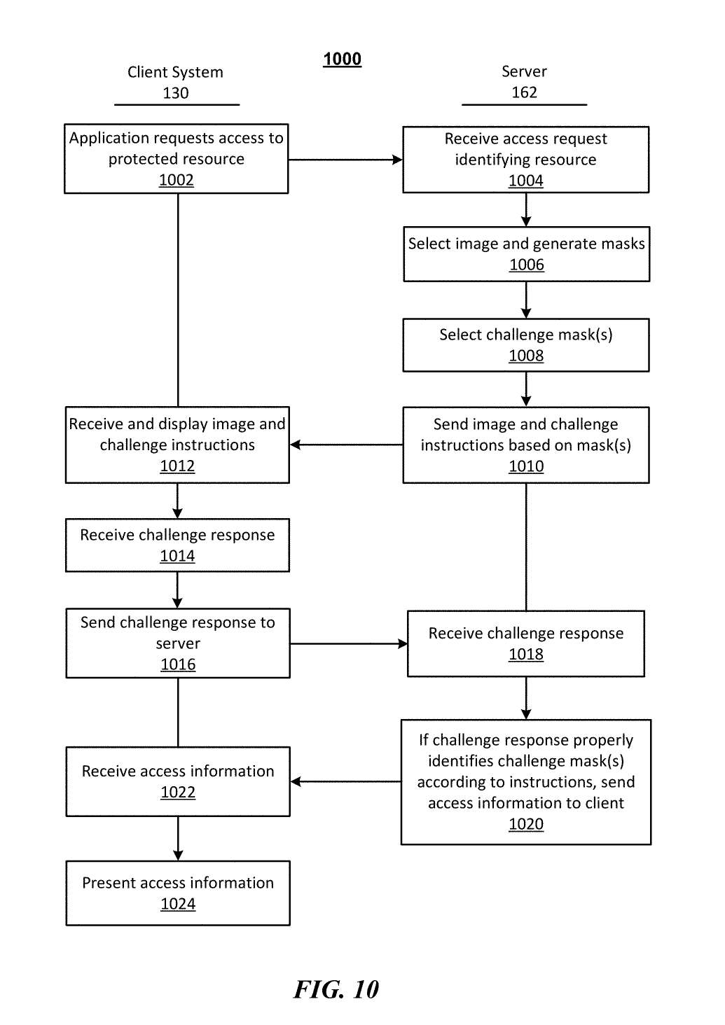

FIG. 10 illustrates an example interaction diagram showing operations performed by a client system 130 and a server 162 in a challenge-response test. At block 1002, an application such as a web browser or other application executing on a client system 130 may request access to a protected resource such as a web page at a particular URL, tickets for an event, patent application information, or other information. The request may identify the resource for which access is being requested, and may be sent in a message via a network 150 to the server 162, e.g., an HTTP request. At block 1004, the server 162 receives the access request.

At block 1006, the server 162 may select an image and generate one or more masks based on the image for the challenge-response test. Parameters of the test, such as the size or complexity of the images, the number of objects in the images, the subject matter of the images, the test instructions, and so on, may be determined based on the resource for which access is being requested. For example, a more difficult challenge-response test, including a more complex image with more details, objects, ambiguity, and the like, may be selected if the resource being protected is valuable or of a type that is known to attract illegitimate automated access requests, such as tickets or reservations for events, airline flights, and so on. More difficult challenge-response tests are likely to use more computing resources of the server 162, e.g., to generate the tests and identify the objects in the image and their perimeters, so the difficulty level of the test (e.g., complexity or size of the image) may be proportional to the protected resource's cost or susceptibility to automated access attacks. The image may be selected from a database of images at random or based on parameters such as size, complexity, subject, or other criteria, as described above. At block 1006, the server 162 may generate masks for objects in the image using an image segmentation technique. Block 1006 may also identify categories of the objects that correspond to the masks, e.g., using an image classification technique.

At block 1008, the server 162 may select the masks to be used in the challenge-response test, e.g., the Alice mask 502 shown in FIG. 5. At block 1010, the server 162 may send the information specifying a challenge-response test, including the selected image, or an identifier for the selected image, and challenge instructions to the client system 130. At block 1012, the client system 130 may receive the challenge-response test information, including the image or image identifier and the challenge instructions, and present the challenge-response test, e.g., by displaying the image and instructions. At block 1014, the client system 130 may receive a challenge response, which may be input tracing a perimeter (e.g., on a touch screen or via a mouse input device), drawing a line or curve (e.g., by a swipe on a touch screen or click-and-drag via a mouse), indicating a point (e.g., by a tap on a touch screen or a mouse click), or performing another action specified in the instructions. The challenge response may be represented as a set of coordinates, vectors, or other type of shape or input event.

At block 1016, the client system 130 may send the challenge response to the server 162, which may determine whether the response is valid. The challenge response may include the response perimeter or other shape or coordinates received as input by the client system 130. At block 1018, the server 162 may receive the challenge response. At block 1020, the server 162 may determine whether the user input may be deemed responsive to the instructions by determining whether the challenge response properly identifies the challenge mask(s) according to the instructions. If the user input may be deemed responsive to the instructions, e.g., if the challenge response properly identifies the challenge mask(s), then the server 162 sends access information for the protected resource to the client system 130. The access information may include a web link to the protected information, a web page containing the protected resource, instructions to be displayed for accessing the protected resource, or computer program instructions to be executed by the client system 130 to access the protected resource. Otherwise, if the challenge response does not properly identify the challenge mask(s), the server 162 may send a response indicating that the user input is not proper, and access is denied (e.g., no access information is sent to the client system 130).

In particular embodiments, to determine whether the response properly identifies the challenge mask(s), the client system 130 may calculate a similarity score for the response perimeter and compare the similarity score to a threshold value or condition. If the comparison indicates that the response perimeter matches the expected perimeter to an acceptable degree of similarity, e.g., because the degree of similarity is greater than or equal to the threshold, then the response properly identifies the challenge mask(s). The threshold may be 0.75, 0.66, 0.50, or other threshold on a scale of 0 (no similarity) to 1 (very similar or identical). The scale may be reversed, e.g., with a score of 0 being identical and 1 for no similarity, in which case comparison to the threshold may determine that the degree of similarity is acceptable when the similarity score is below a threshold such as 0.25, 0.33, of 0.50. If the comparison indicates that the response perimeter does not match the expected perimeter to an acceptable degree of similarity, e.g., because the similarity score is less than the threshold, then information indicating the user input failed the challenge-response test may be displayed on the client system 130. At block 1022, the client system may receive the access information. At block 1024, the client system may present the access information or perform another action based on the access information, such as executing instructions included in or associated with the access information.

Particular embodiments may repeat one or more steps of the method of FIG. 10, where appropriate. Although this disclosure describes and illustrates particular steps of the method of FIG. 10 as occurring in a particular order, this disclosure contemplates any suitable steps of the method of FIG. 10 occurring in any suitable order. Moreover, although this disclosure describes and illustrates an example method for performing a challenge-response test based on image segmentation and classification including the particular steps of the method of FIG. 10, this disclosure contemplates any suitable method for performing a challenge-response test based on image segmentation and classification including any suitable steps, which may include all, some, or none of the steps of the method of FIG. 10, where appropriate. Furthermore, although this disclosure describes and illustrates particular components, devices, or systems carrying out particular steps of the method of FIG. 10, this disclosure contemplates any suitable combination of any suitable components, devices, or systems carrying out any suitable steps of the method of FIG. 10.

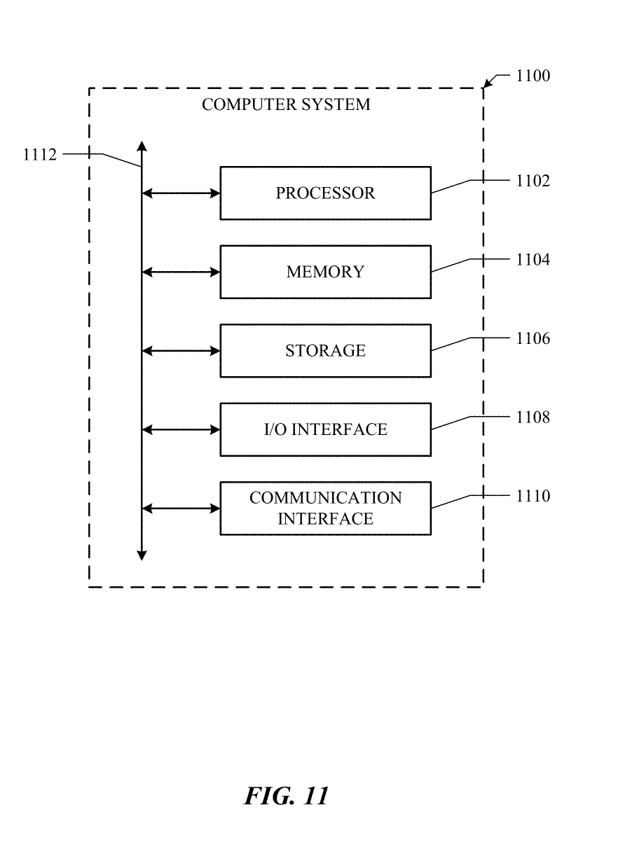

FIG. 11 illustrates an example computer system 1100. In particular embodiments, one or more computer systems 1100 perform one or more steps of one or more methods described or illustrated herein. In particular embodiments, one or more computer systems 1100 provide functionality described or illustrated herein. In particular embodiments, software running on one or more computer systems 1100 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 for instructions executing at processor 1102 to operate on; the results of previous instructions executed at processor 1102 for access by subsequent instructions executing at processor 1102 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 1102. Although this disclosure describes and illustrates a particular processor, this disclosure contemplates any suitable processor.

In particular embodiments, memory 1104 includes main memory for storing instructions for processor 1102 to execute or data for processor 1102 to operate on. As an example and not by way of limitation, computer system 1100 may load instructions from storage 1106 or another source (such as, for example, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described below. In particular embodiments, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In particular embodiments, storage 1106 includes mass storage for data or instructions. As an example and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In particular embodiments, storage 1106 is non-volatile, solid-state memory. In particular embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In particular embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In particular embodiments, communication interface 1110 includes hardware, software, or both providing one or more interfaces for communication (such as, for example, packet-based communication) between computer system 1100 and one or more other computer systems 1100 or one or more networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it. As an example and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by a computing device, receiving a request for a protected resource;
by the computing device, providing information to display a challenge-response test, wherein the challenge-response test comprises an image and instructions to provide user input in relation to the image, wherein the image comprises one or more masks, and wherein each of the one or more masks is defined by a perimeter;
by the computing device, receiving user input in relation to the image;
by the computing device, generating an assessment of the user input based on a correlation between the user input and the one or more masks;
by the computing device, determining, based on the assessment, whether the user input may be deemed responsive to the instructions; and
by the computing device, if the user input corresponds to human-generated input, then providing information to access the protected resource, else providing information indicating that the user input failed the challenge-response test.

2. The method of claim 1, wherein each of the one or more masks comprises a classification, and wherein the instructions comprise instructions to provide user input in relation to the classification.

3. The method of claim 1:
wherein the generating the assessment of the user input comprises computing a score based on the correlation between the user input and the one or more masks, wherein the correlation is between one or more attributes indicated by the user input and attributes associated with the one or more masks; and
wherein the determining, based on the assessment, whether the user input may be deemed responsive to the instructions comprises determining whether the score satisfies a threshold condition.

4. The method of claim 3, wherein the attributes comprise one or more locations, names, labels, or colors.

5. The method of claim 1, wherein the request is associated with a user, further comprising:
retrieving content associated with the user, wherein the image comprises the content, and wherein the instructions are customized for the user.

6. The method of claim 1, wherein the instructions request user input indicating one or more regions of the image each corresponding to one of the masks.

7. The method of claim 6, wherein the user input comprises gesture input, text input, or voice input.

8. The method of claim 7, wherein the gesture input comprises a tap on one of the indicated regions, a tracing gesture delineating one of the indicated regions, or a tracing gesture connecting two or more of the indicated regions.

9. The method of claim 7, wherein the text input comprises one or more identifiers that correspond to one or more of the indicated regions.

10. The method of claim 7, wherein the voice input comprises a description identifying one or more of the indicated regions.

11. The method of claim 1, wherein the instructions request user input indicating one or more regions of the image each corresponding to one of the masks.

12. One or more computer-readable non-transitory storage media embodying software that is operable when executed to:
receive a request for a protected resource;
provide information to display a challenge-response test, wherein the challenge-response test comprises an image and instructions to provide user input in relation to the image, wherein the image comprises one or more masks, and wherein each of the one or more masks is defined by a perimeter;
receive user input in relation to the image;
generate an assessment of the user input based on a correlation between the user input and the one or more masks;
determine, based on the assessment, whether the user input may be deemed responsive to the instructions; and
if the user input corresponds to human-generated input, then providing information to access the protected resource, else providing information indicating that the user input failed the challenge-response test.

13. The media of claim 12, wherein each of the one or more masks comprises a classification, and wherein the instructions comprise instructions to provide user input in relation to the classification.

14. The media of claim 12, wherein to generate the assessment of the user input, the software is further operable when executed to compute a score based on the correlation between the user input and the one or more masks, wherein the correlation is between one or more attributes indicated by the user input and attributes associated with the one or more masks; and
wherein to determine, based on the assessment, whether the user input corresponds to human-generated input, the software is further operable when executed to determine whether the score satisfies a threshold condition.

15. The media of claim 12, wherein the request is associated with a user, and the software is further operable when executed to:
retrieve content associated with the user, wherein the image comprises the content, and wherein the instructions are customized for the user.

16. A system comprising: one or more processors; and a memory coupled to the processors comprising machine instructions executable by the processors, the processors being operable when executing the machine instructions to:
receive a request for a protected resource;
provide information to display a challenge-response test, wherein the challenge-response test comprises an image and challenge instructions to provide user input in relation to the image, wherein the image comprises one or more masks, and wherein each of the one or more masks is defined by a perimeter;
receive user input in relation to the image;
generate an assessment of the user input based on a correlation between the user input and the one or more masks;
determine, based on the assessment, whether the user input can be deemed responsive to the instructions; and
if the user input corresponds to human-generated input, then providing information to access the protected resource, else providing information indicating that the user input failed the challenge-response test.

17. The system of claim 16, wherein each of the one or more masks comprises a classification, and wherein the machine instructions comprise machine instructions to provide user input in relation to the classification.

18. The system of claim 16, wherein to generate the assessment of the user input, the processors are further operable when executing the machine instructions to compute a score based on the correlation between the user input and the one or more masks, wherein the correlation is between one or more attributes indicated by the user input and attributes associated with the one or more masks; and
wherein to determine, based on the assessment, whether the user input corresponds to human-generated input, the processors are further operable when executing the machine instructions to determine whether the score satisfies a threshold condition.

19. The system of claim 16, wherein the request is associated with a user, and the processors are further operable when executing the machine instructions to:
retrieve content associated with the user, wherein the image comprises the content, and wherein the challenge instructions are customized for the user.

20. The system of claim 16, wherein the challenge instructions request user input indicating one or more regions of the image each corresponding to one of the masks.
